(19) United States
(12) Patent Application Publication
(10) Pub. No.: US 2008/0259272 A1
(43) Pub. Date: Oct. 23, 2008

(54) Eyewear for Redirected Viewing

(76) Inventor: Bahman Shahrarami, Centreville, VA (US)

Correspondence Address: HANSEN HUANG TECHNOLOGY LAW GROUP, LLP, 1725 EYE STREET, NW, SUITE 300, WASHINGTON, DC, 20006, US

(21) Appl. No.: 11/738,398

(22) Filed: Apr. 20, 2007

(51) Int. Cl. G02C 7/14

(52) U.S. Cl. 351/175

(57) ABSTRACT

A pair of spectacles for providing a redirected view includes a visor configured to support a pair of triangular optical prisms attached to the bottom surface of the visor in front of a wearer's eyes. The prisms provide an internally reflected and refracted path approximately normal to the forward vision allowing the wearer to view scenes without head or body reorientation. The visor and the prisms are oriented at an angle of 5 to 15 degrees below horizontal, as defined by the spectacles' handle portion, to position the prisms at an optimal viewing angle to enhance wearer comfort. The prisms are made wide and spaced close together to provide a panoramic perspective, with the inside lower corner radiused to provide room for a wearer's nose.

### FIELD OF THE INVENTION

This invention relates to optical appliances, and more particularly to eyewear for redirecting the vision of a wearer.

### BACKGROUND OF THE INVENTION

Optical devices for redirecting fields of view have been proposed for varying applications to enable a wearer to view a scene offset from the normal line of sight. With such devices, the wearer is able to secure desired views without changing body and head positions and/or by superimposing backgrounds for facilitating or ameliorating certain conditions.

In U.S. Pat. No. 5,042,910 to Dolezal a removable elongated plastic prism is interfaced with a slotted shield for redirecting the field of vision of the wearer. The shield and associated frame are intended for blocking all images not passing through the prismatic lenses.

U.S. Pat. No. 4,804,261 to Kirschen discloses a rearward mirrored viewing system for patients prone to claustrophobia. Therein a mirror mounted on frames provides a rearwardly directed, background view at the end of a magnetic resonance instrument thereby providing an artificial backdrop removing the tunnel like aspects and resulting claustrophobia associated with the examination.

U.S. Pat. No. 4,647,165 to Lewis provides an optical viewing system for bike riders wherein prisms are attached to clip-on spectacle frames and pivot downward to an operative position engaging the lens when the riders head is lowered thereby providing a redirected view forwardly of the bike.

U.S. Pat. No. 4,792,223 to Axelbaum discloses an optical device incorporated into eyewear frames wherein a lower mirrored secondary lens supported in front of and inclined with respect to a primary lens is effective for providing a secondary field of view that is superimposed on a primary field of view.

U.S. Pat. No. 6,006,367 to Webster discloses swimming goggles incorporating a prismed element allowing a wearer through eye redirection to achieve a secondary field of vision.

U.S. Pat. No. 5,173,720 to Lee et al. discloses a specialty eyewear device including a slotted frame having mirrored surfaces angularly disposed with respect thereto. The wearer may view forwardly through the slots for normal straight ahead viewing. Alternatively, the wearer may view downwardly through the slots to achieve a redirected view as affected by the mirrored surfaces.

U.S. Pat. No. 4,077,703 to Pablo discloses an eye frame incorporating prisms housed in an elongated frame overlying the wearer's face and disposed in front of the view's eyes for redirecting normal line of sight for reading or viewing.

U.S. Pat. No. 2,123,682 to Wingate discloses laterally slidable prisms mounted in eyewear frames for redirecting normal vision angles. The frames and peripheral shrouds for the prisms surround the prisms thereby effectively limiting frontal viewing to the prismed areas and to the exclusion of surrounding peripheral information.

U.S. Pat. No. 6,280,031 to Zerkle discloses prisms mounted in eyewear frames for redirecting normal vision angles with frames and lenses constructed so as to not block the peripheral vision of the wearer.

### SUMMARY OF THE INVENTION

The present invention provides optical spectacles that provide a redirected view and have design features to reduce eyestrain and increase comfort of the wearer. A visor configured to be positioned on the wearer at the brow line supports a pair of triangular optical prisms attached to the bottom surface of the visor in front of the wearer's eyes. The prisms provide an internally reflected and refracted path normal to the forward vision allowing the wearer to view scenes without head or body reorientation, such as watching television from a supine position. The visor, and thus the prisms, are oriented at an angle of 5 to 15 degrees below horizontal, as defined by the spectacles'handle portion, to position the prisms at an optimal viewing angle to enhance wearer comfort. The visor is shaped for a comfortable fit on the human forehead. The size, width and the shape of this visor makes for an easy universal fit on the brow line of various shapes and sizes of foreheads. The prisms are wide to enhance viewing so the wearer can easily see the desired scene without having to hunt for the view or ignore other images in the wearer's field of vision. To ensure the prisms do not press upon the nose of the wearer, the lower, inner corner of each prism is provided with a radius. A soft rubber pad at the center of the visor evenly distributes the weight of the spectacles on the forehead to prevent discomfort due to weight. In addition, the pad lifts the visor and the prisms away from the brow line allowing for the spectacles to lay over most conventional prescription or sun glasses eyewear. A visor side protection shaped to match the sides of the prism prevents light from entering the triangular prisms from the outer sides thereby preventing distortion or false images due to light absorption, refraction and/or reflection from the sides. The side protection also serves to protect the prisms from side damage. A coding applied to the parallel end wall of the triangular prisms further prevents light from entering the prisms from the inner sides.

### DESCRIPTION OF THE DRAWINGS

The benefits of the present invention will become apparent upon reading the following detailed description taken in conjunction with the accompanying drawings in which:

FIG. 1 is a front elevational view of an embodiment of spectacles for providing the wearer with a redirected field of view in accordance with a preferred targeted view;

FIG. 2 is a side cross sectional view taken along line LL′ in FIG. 1;

FIG. 3 is a bottom view of the spectacles;

FIG. 4 is a is a top view of the spectacles

FIG. 5 is a vertical schematic view of the redirected field of view provided by the spectacles of FIG. 1;

FIG. 6 is a cross sectional view of the pentahedral shape, triangular prism;

FIGS. 7A-7C show the spectacles with representative dimensions identified; and

FIG. 8 shows the entire profile of an embodiment of the spectacles.

### DETAILED DESCRIPTION

This invention provides eyewear in the form of a pair of spectacles that enables the wearer to view objects situated at a considerable angle (60 to 120 degrees) to the direct line of vision with comfort and without distraction. This invention can be used, for example, for watching TV while laying on one's back looking toward the ceiling.

Embodiments of the present invention will be described in detail with reference to the accompanying drawings. Wherever possible, the same reference labels will be used throughout the drawings to refer to the same or like parts.

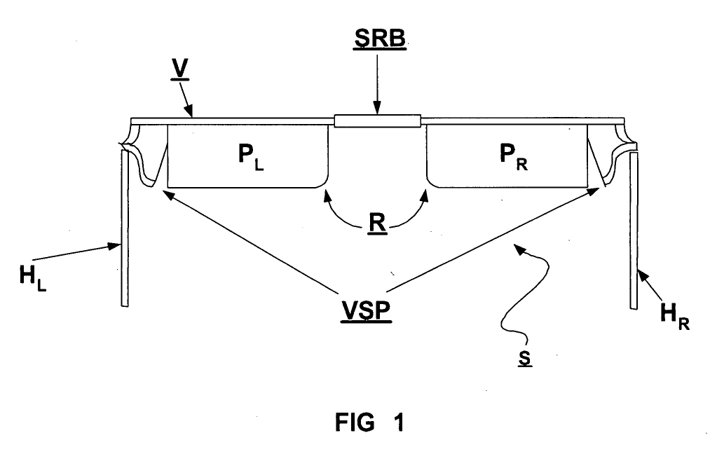

Referring to FIGS. 1-5, the eyewear in the form of prismatic optical spectacles S are configured so that when worn by a wearer or user U, the wearer experiences a redirected line of sight DE from a normal forward viewing path D′E′. Such redirected viewing allows the wearer to engage in various viewing activities otherwise requiring extensive body, neck or head repositioning.

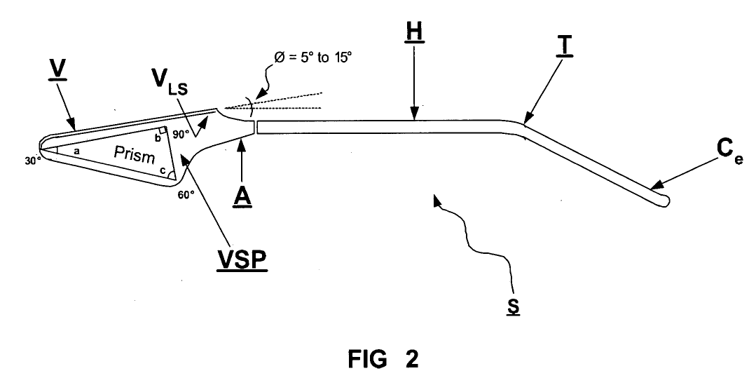

The spectacles S include a frontal visor V having left and right arms A_{L} and A_{R} that attach by means of hinges h to left and right handles H_{L}, H_{R}. The left and right handles H_{L}, H_{R} connect to temples T for engaging the temple and ear of the wearer. A pair of laterally spaced left and right prismatic elements P_{L} and P_{R} are attached to the lower surface V_{LS} of the visor V. As shown in FIG. 2, the visor V is oriented with an angle of declination with respect to the handle H of between approximately 5 and 15 degrees (i.e., the visor V is inclined with respect to the handles H_{L}, H_{R}). A visor side panel VSP extends downwardly from the visor V on either side, thereby blocking the outer sides of the prisms.

Referring to FIG. 2, the temples T are of conventional eyewear construction and connect to the horizontally extending handles H_{L}, H_{R} on one end and terminate with downwardly curved ends Cₑ on the other end for engaging the ear area of the wearer. The inner frontal end of each handle H_{L}, H_{R} connects to a hinge section H_{S} which provides the structure for the hinge h. The hinge h features a conventional pin for pivotal movement about a vertical axis between the illustrated wearing position and a collapsed position wherein the temples abut the rear arms of the visor.

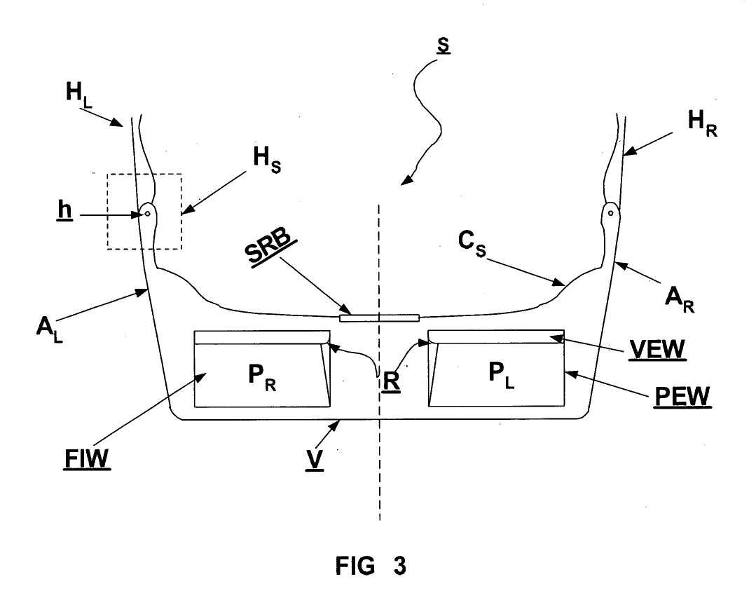

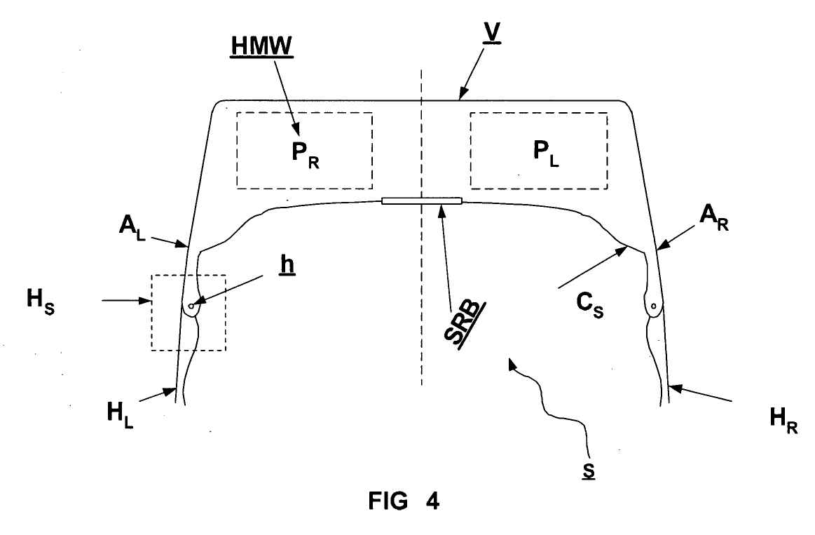

As illustrated in FIGS. 3 and 4, the visor V is configured with an inner edge profile that permits the spectacles S to be supported on the wearer's forehead. A soft rubber bridge SRB is connected to the visor V between the prismatic elements on the rear edge of the visor V. The soft rubber bridge SRB can be made from silicone, rubber foam, plastic or soft rubber, is centered on the inside surface of the visor V, and is sized and configured to register with the forehead between the eyebrows and the nose bridge of the wearer.

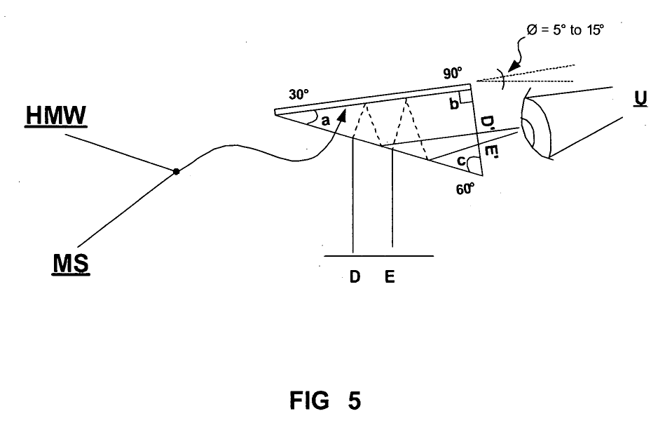

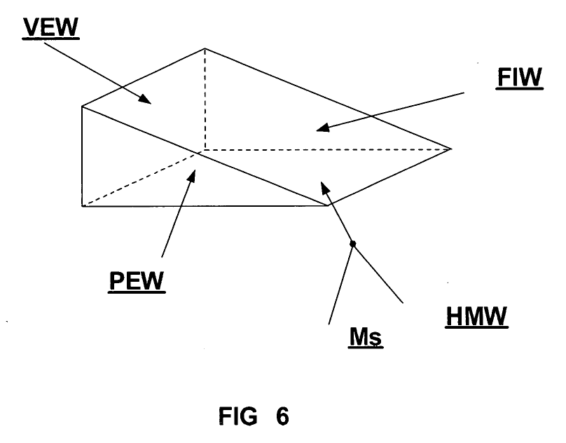

Referring to FIGS. 3 and 6, the prisms P_{L}, P_{R} are symmetrically disposed on the lower surface of the visor V. The prisms P_{L}, P_{R} may be made of optical grade glass, clear resin or thermoplastics, and are heptahedral in shape with a side view shape defining a right-triangle, with a parallel end walls PEW, a vertical end wall VEW, a horizontal mounting wall HMW, and a frontal inclined wall FIW. The horizontal mounting wall HMW of each prism P_{L}, P_{R} is adhered to the lower surface V_{LS} of the visor V by a suitable adhesive as illustrated in FIG. 4. The prisms P_{L}, P_{R} are mounted on the visor V and sized so that the eyes of the wearer are directed on the vertical end wall VEW for normal forward vision with a slight downward inclination as defined by the angle of declination, as shown in FIG. 5.

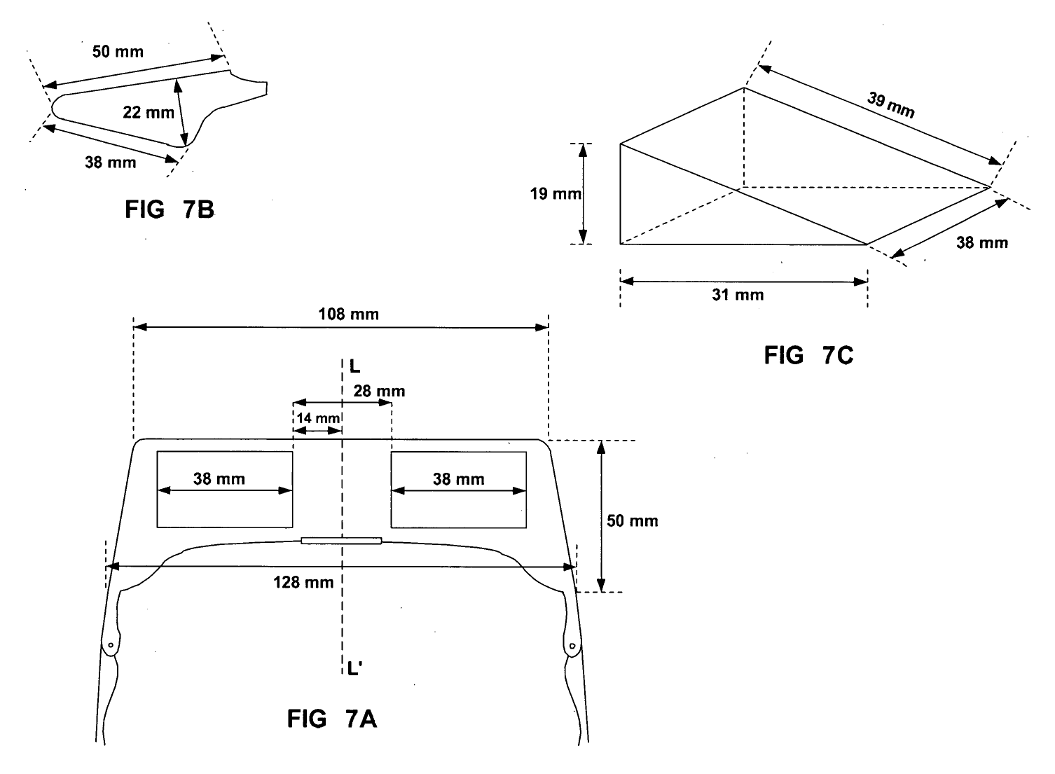

The visor V, SRB and the temples are positioned at the normal vertical cutoff and thus disposed outwardly of the field of view. Such disposition also allows the spectacles to be conveniently worn over conventional glasses. The prisms P_{L}, P_{R} are spaced sufficiently close together and have sufficient width (see FIG. 7A) to provide continuous binocular viewing with a panoramic view and without blind spots or other discontinuities. The width of the vertical end wall VEW is designed to accommodate most variations of inter-ocular distances.

Referring to FIGS. 5 and 6, the prisms P_{L}, P_{R} function in a well known manner to reflect and refract images. In the present invention, the end walls PEW of the prisms P_{L}, P_{R} are coated with black or opaque material to be non-reflective and non translucent. Additionally, the vertical side panel VSP extending down from the visor V blocks light from entering the outer sides of the prisms P_{L}, P_{R}. The painted or frosted surfaces and the vertical side panel VSP are provided so secondary images and light are not transmitted into the prisms P_{L}, P_{R} which could result in discernable visible false images and distracting lights.

The vertical end wall VEW of the prisms P_{L}, P_{R} have a clear polished surface and is located in the wearer's direct line-of-sight. The horizontal mounting wall HMW of the prisms P_{L}, P_{R} has a mirrored surface MS, preferably silvered or otherwise reflectively coated. The forward inclined wall FIW of the prisms P_{L}, P_{R} features a clear polished surface and receives the images reflected by the surface MS for internal reflection to the front wall surface and refraction to the wearer. It will be appreciated that the prisms are effective for providing a redirected field of vision DE, substantially normal to the line-of-sight D′E′, as prescribed by the angularities between the prism walls. Various angularities may be adopted for accomplishing the foregoing. In the preferred embodiment, a substantially perpendicular redirection of vision is provided, with the angle of vision redirection being measured from the plane defined by the left and right handles H_{L}, H_{R}. In the preferred embodiment, the prisms have interior angles of approximately 90° for angle b, approximately 60° for angle c and approximately 30° for angle a as illustrated in FIG. 5.

The size of the prisms P_{L}, P_{R}, particularly their width, are set to ensure a wide field of view that is consistent with a wearer's normal perspective. As illustrated in FIG. 7A, the visor V has a width of approximately 50 mm on the top surface, and the two prisms P_{L}, P_{R} each have a width of approximately 38 mm. The prisms P_{L}, P_{R} are each displaced approximately 14 mm from the centerline of the visor V. So positioned, the prisms P_{L}, P_{R} fill much of the wearer's forward vision, and are wide enough to provide a comfortable left-right panoramic view.

Representative dimension of the prisms P_{L}, P_{R} are illustrated in FIG. 7C. Specifically, the prisms P_{L}, P_{R} have a width of approximately 38 mm, a height of approximately 19 mm, a base of approximately 31 mm, and a hypotenuse of approximately 39 mm.

As illustrated in FIG. 1, the inner lower corner of each prism P_{L}, P_{R} is provided with a radius R. This radius R serves two functions. First, the radius R provides additional space between the wearer's nose and the prisms P_{L}, P_{R} while permitting the prisms to extend close together. Positioning the prisms P_{L}, P_{R} close together provides a wider panoramic view, thereby improving the wearer's vision and comfort. To allow this close spacing while providing a universal fit on most noses, the portion of the lower inside corner of the prisms P_{L}, P_{R} (where the wearer does not have normal vision) is removed to provide the radius R. The second function of the radius R is to prevent injury to the wearer that could occur if the inner lower corner of the prisms P_{L}, P_{R} was sharp. The radius R at the lower right corner of PL and the lower left corner of PR, located on the VEW, prevents puncture of skin should the prism accidentally come in contact with the nose.

As illustrated in FIG. 7B, the vertical side panel VSP extends along the length of the visor (approximately 50 mm) and has a length of approximately 38 mm and a height of approximately 22 mm.

As mentioned above and illustrated in FIGS. 2, 4 and 5, the visor's lower surface VLS is inclined below the horizontal plane as defined by the handles by an angle between approximately 5 and 15 degrees (referred to herein as an angle of declination). This angle of declination positions the prisms at an optimal angle for viewing by a wearer that helps the wearer find the desired redirected scene without hunting for it within the wearer's field of vision. Additionally, this angle reduces height of the prism (i.e., reduces angle “a” in FIG. 5) that is necessary to achieve 90 degree angle of viewing redirection, thereby reducing the size and weight of the prisms. As used herein, the angle of redirection refers to the angle between the horizontal plane defined by the handles and the resulting line of sight, as illustrated in FIG. 5. This declination of the visor and viewing prisms is not disclosed in the prior designs discussed in the Background section, since those references taught that the top surface of the prisms should be maintain parallel to the handle. The inventor has determined that presenting the prisms at an angle of declination of between approximately 5 and 15 degrees results in more comfortable viewing due to the relaxed position of the eyes. Additionally, the angle of declination in combination with the vision-blocking effect of the visor helps to fill the field of vision of the wearer along the wearer's vertical axis, which reduces distractions from images below the prism without increasing the size of the prism. These various effects from the angle of declination combine to provide the wearer with a comfortable and easy viewing capability.

Referring to FIG. 7A, the width of the prisms presents the redirected field of view to the wearer with out the need to hunt for the image, thus preventing wearer fatigue. In addition, it provides the wearer with an easy viewing experience, giving the wearer the feel and perception of a panoramic view.

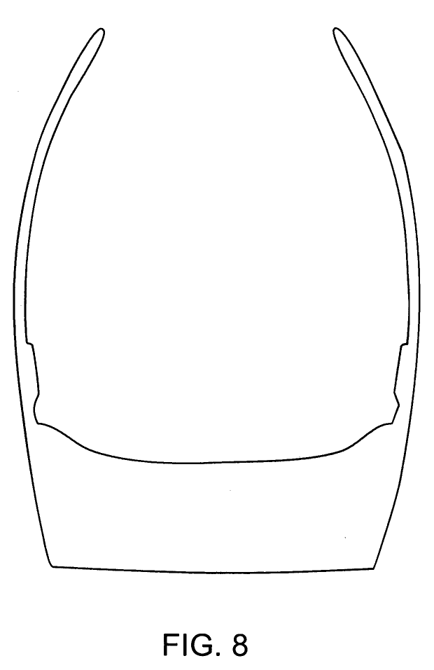

FIG. 8 shows a top perspective view of the entire spectacles. As illustrated, the handles H_{L}, H_{R} and the temples T may be formed with an inward curvature to fit the contours of the wearer's head, while the inner edge of the visor V is curved to approximate the profile of the wearer's forehead.

The eyewear constructed in accordance with the foregoing description present a redirected view to a wearer. In particular, the angle of declination of the visor V and the depending prisms P_{L}, P_{R}, combined with the width of the prisms P_{L}, P_{R}, are such that the redirected view is presented within the wearer's normal field of view, providing a panoramic view. As a result there is reducing wearer fatigue. The vertical side panel VSP on both sides of the prisms P_{L}, P_{R} blocks a forward portion of normal peripheral vision of the wearer thereby removing distracting images of scenery that is not rotated by 60-120 degrees, which can cause difficulty in focusing on the object of interest. The soft rubber bridge SRB on the inside edge of the visor V spreads the weight of the spectacles over the wearer's forehead, further increasing the wearer's comfort.

The following table lists the reference indicia provided in the drawings.

| | |
|---|---|
| A | Arm |
| A_{L} | Left Arm |
| A_{R} | Right Arm |
| Cₑ | Curved End |
| C_{S} | Curve Section |
| FIW | Frontal Inclined Wall |
| H | Handle |
| h | Hinge |
| H_{L} | Left Handle |
| HMW | Horizontal Mounting Wall |
| H_{R} | Right Handle |
| MS | Mirrored Surface |
| PEW | Parallel End Wall |
| P_{L} | Left Prism |
| P_{R} | Right Prism |
| S | Spectacles |
| SRB | Soft Rubber or Silicon Bridge |
| T | Temple |
| U | User or wearer |
| V | Visor |
| VEW | Vertical Mounting Wall |
| V_{LS} | Visor Lower Surface |
| VSP | Visor Side Panel |

While the present invention has been disclosed with reference to certain exemplary embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

I claim:

1. Eyewear for providing a redirected field of vision, comprising:
a visor coupled to a pair of handles each coupled to a curved temple, the visor having a lower surface, an inner edge and two side edges;
a pair of triangular optical prisms each having a top surface, an inner side, and an outer side, wherein
the prisms are coupled on their top surface to the lower surface of the visor positioned approximately 14 mm apart,
the top surface of each prism is a mirrored surface,
an opaque coating is applied on the inner side of each prism, and each prism has a radiused portion on a lower inside corner;
two vertical side panels coupled to the visor one on each side edge, the vertical side panels sized to reduce light entering into the outer side of each of the pair of prisms; and
a soft rubber bridge coupled to the inner edge of the visor,
wherein the visor is angled downward from the handles with an angle of declination between approximately 5 degrees and approximately 15 degrees.

2. The eyewear according to claim 1, wherein each of the pair of prisms has a width dimension of approximately 38 mm, a base dimension of approximately 31 mm and a height dimension of approximately 19 mm.

3. The eyewear according to claim 1, wherein each of the pair of prisms are dimensioned to provide a redirected view that is approximately perpendicular to the handles when the spectacles are positioned on a wearer.

4. The eyewear according to claim 1, wherein the inner edge of the visor is shaped to approximately conform to a wearer's forehead.
